(19) United States
(12) Patent Application Publication
(10) Pub. No.: US 2012/0250305 A1
(43) Pub. Date: Oct. 4, 2012

(54) LED BULB

(75) Inventors: Hirotaka SHIMIZU, Kyoto (JP); Hideharu OSAWA, Kyoto (JP)

(73) Assignee: ROHM CO., LTD., Kyoto (JP)

(21) Appl. No.: 13/435,215

(22) Filed: Mar. 30, 2012

(30) Foreign Application Priority Data
Mar. 31, 2011 (JP) 2011-080839
May 11, 2011 (JP) 2011-105834

(51) Int. Cl. F21V 9/00; F21V 3/00

(52) U.S. Cl. 362/231; 362/235

(57) ABSTRACT

An LED bulb includes one or more light emitting parts including one or more LED chips, a mount including a bulging portion in which one or more mounting surfaces on which the one or more light emitting parts are mounted are formed, a base attached to the mount, and a globe which covers the bulging portion and transmits light.

### CROSS-REFERENCE TO RELATED APPLICATION(S)

This application is based upon and claims the benefit of priority from Japanese Patent Application Nos. 2011-080839 and 2011-105834, filed on Mar. 31, 2011 and May 11, 2011, respectively, the entire contents of which are incorporated herein by reference.

### TECHNICAL FIELD

The present disclosure relates to an LED bulb including an LED chip as a light source.

### BACKGROUND

FIG. 32 shows a conventional LED bulb. As shown in FIG. 32, an LED bulb 900 includes an LED substrate 901, a plurality of LED chips 902, a base 903, a power supply 904, a cap 905 and a globe 906. The plurality of LED chips 902 serves as a light source of the LED bulb 900 and is mounted on the LED substrate 901. The LED substrate 901 is made of an insulating material and is fixed to the base 903. The base 903 is made of a metal such as aluminum and serves to dissipate heat from the plurality of LED chips 902. The cap 905 is a part for attaching the LED bulb 900 to a lighting apparatus and has a specification defined by, for example, JIS (Japanese Industrial standards). The globe 906 protects the plurality of LED chips 902 and transmits light from the LED chips 902.

Light from the plurality of LED chips 902 has the highest brightness in an upper part in the figure and a relatively low brightness in side parts in the figure. In addition, it is difficult for the light from the LED chips 902 to arrive at an inclined lower part in the figure. Therefore, if the LED bulb 900 is attached to the lighting apparatus, instead of a general incandescent bulb, there appear two different ranges, that is, a bright range with sufficient illumination and a dark range with insufficient illumination.

### SUMMARY

The present disclosure provides some embodiments of an LED bulb which is capable of illuminating over a wide range with sufficient luminance and a bulb type LED lighting device with a wide range of illumination.

According to one aspect of the present disclosure, there is provided an LED bulb. The LED bulb includes one or more light emitting parts including one or more LED chips, a mount including a bulging portion in which one or more mounting surfaces on which the one or more light emitting parts are mounted are formed, a base attached to the mount, and a globe which covers the bulging portion and transmits light.

With this configuration, the light emitting parts mounted on the mounting surfaces of the bulging portion emit light at a position closer to the center of the globe. If the light from the light emitting parts passes through the globe, the LED bulb illuminates in different directions, thereby providing more uniform illumination over a wider range.

According to one embodiment, the LED bulb further includes a secondary diffusive light source which covers the bulging portion. The secondary diffusive light source is interposed with a gap between the light emitting parts and the globe, and diffuses and transmits light from the light emitting parts.

According to another embodiment, the secondary diffusive light source includes a fluorescent material which emits light having a wavelength different from a wavelength of light from the LED chips through excitation of the fluorescent material by the light from the LED chips.

According to another embodiment, the secondary diffusive light source is made of transparent resin mixed with the fluorescent material.

According to another embodiment, the secondary diffusive light source includes a transparent layer made of transparent resin and a fluorescent layer including the fluorescent material stacked on the transparent layer.

According to another embodiment, the transparent layer is placed at the side of the light emitting parts with respect to the fluorescent layer.

According to another embodiment, the secondary diffusive light source includes a transparent layer which surrounds a lateral side of the light emitting parts and is made of transparent resin, and a fluorescent layer which is located in front of the light emitting parts and includes the fluorescent material.

According to another embodiment, the secondary diffusive light source has a rotational symmetrical shape.

According to another embodiment, the secondary diffusive light source has a cylindrical portion and a domical portion.

According to another embodiment, the secondary diffusive light source has a conical shape.

According to another embodiment, the secondary diffusive light source has a truncated conical shape.

According to another embodiment, the secondary diffusive light source has a bottomed cylindrical shape.

According to another embodiment, the secondary diffusive light source has a partially spherical shape.

According to another embodiment, the secondary diffusive light source has a rectangular parallelepiped shape.

According to another embodiment, the globe diffuses and transmits light.

According to another embodiment, the bulging portion includes at least three mounting surfaces. Further, each of the three mounting surfaces has an apex and two sides extending from the apex. The respective apexes coincide with each other and the respective adjacent sides come in contact with each other.

According to another aspect of the present disclosure, each of the mounting surfaces has a square shape.

According to another embodiment, the bulging portion includes a circular mounting surface and a tapered cylindrical lateral side whose section dimension increases from the circular mounting surface toward the base.

According to another embodiment, the light emitting parts have respective LED substrates on which the one or more LED chips are mounted.

According to another embodiment, each of the LED substrate is made of ceramic.

According to another embodiment, a plurality of LED chips is arranged in the form of a matrix on each of the LED substrates.

According to another embodiment, the light emitting parts have sealing resin which seals the LED chips and transmits light from the LED chips.

According to another embodiment, the light emitting parts include a dam portion which is formed in an edge shape on the LED substrates and encloses the sealing resin.

According to another aspect of the present disclosure, there is provided an LED bulb. The LED bulb includes one or more light emitting parts including one or more LED chips, and a mount including one or more mounting surfaces on which the one or more light emitting parts are mounted. Further, the LED bulb includes a base attached to the mount, a globe which covers the bulging portion and transmits light, and a secondary diffusive light source which is interposed with a gap between the light emitting parts and the globe, and diffuses and transmits light from the light emitting parts.

Other features and advantages of the present disclosures will become more apparent from the following detailed description in conjunction with the accompanying drawings.

### BRIEF DESCRIPTION OF THE DRAWINGS

FIG. 1 is a perspective view illustrating an LED bulb according to a first embodiment of the present disclosure.

FIG. 2 is a plan view showing the main parts of the LED bulb of FIG. 1.

FIG. 3 is a sectional view taken along line in FIG. 2.

FIG. 4 is a sectional view illustrating a light emitting part of the LED bulb of FIG. 1.

FIG. 5 is an enlarged sectional view illustrating the main parts of a case of the LED bulb of FIG. 1.

FIG. 6 is a sectional view illustrating an LED bulb according to a second embodiment of the present disclosure.

FIG. 7 is a sectional view illustrating an LED bulb according to a third embodiment of the present disclosure.

FIG. 8 is a sectional view illustrating an LED bulb according to a fourth embodiment of the present disclosure.

FIG. 9 is a perspective view illustrating an LED bulb according to a fifth embodiment of the present disclosure.

FIG. 10 is a sectional view illustrating the LED bulb according to the fifth embodiment of the present disclosure.

FIG. 11 is a sectional view illustrating an LED bulb according to a sixth embodiment of the present disclosure.

FIG. 12 is a sectional view illustrating an LED bulb according to a seventh embodiment of the present disclosure.

FIG. 13 is a sectional view illustrating an LED bulb according to an eighth embodiment of the present disclosure.

FIG. 14 is a sectional view illustrating an LED bulb according to a ninth embodiment of the present disclosure.

FIG. 15 is a sectional view illustrating an LED bulb according to a tenth embodiment of the present disclosure.

FIG. 16 is a sectional view illustrating an LED bulb according to an eleventh embodiment of the present disclosure.

FIG. 17 is a sectional view illustrating an LED bulb according to a twelfth embodiment of the present disclosure.

FIG. 18 is a sectional view illustrating an LED bulb according to a thirteenth embodiment of the present disclosure.

FIG. 19 is a sectional view illustrating an LED bulb according to a fourteenth embodiment of the present disclosure.

FIG. 20 is a sectional view illustrating an LED bulb according to a fifteenth embodiment of the present disclosure.

FIG. 21 is a perspective view illustrating an LED lamp according to a first embodiment of another aspect of the present disclosure.

FIG. 22 is a sectional view illustrating the LED lamp according to the first embodiment of the second aspect of the present disclosure.

FIG. 23 is a sectional view illustrating an LED lamp according to a second embodiment of the second aspect of the present disclosure.

FIG. 24 is a sectional view illustrating an LED lamp according to a third embodiment of the second aspect of the present disclosure.

FIG. 25 is a sectional view illustrating an LED lamp according to a fourth embodiment of the second aspect of the present disclosure.

FIG. 26 is a sectional view illustrating an LED lamp according to a fifth embodiment of the second aspect of the present disclosure.

FIG. 27 is a sectional view illustrating an LED lamp according to a sixth embodiment of the second aspect of the present disclosure.

FIG. 28 is a sectional view illustrating an LED lamp according to a seventh embodiment of the second aspect of the present disclosure.

FIG. 29 is a sectional view illustrating an LED lamp according to an eighth embodiment of the second aspect of the present disclosure.

FIG. 30 is a sectional view illustrating an LED lamp according to a ninth embodiment of the second aspect of the present disclosure.

FIGS. 31A and 31B are sectional views illustrating a comparison between the LED lamp according to the first embodiment of the second aspect of the present disclosure and a conventional krypton bulb.

FIG. 32 is a sectional view illustrating a conventional LED bulb.

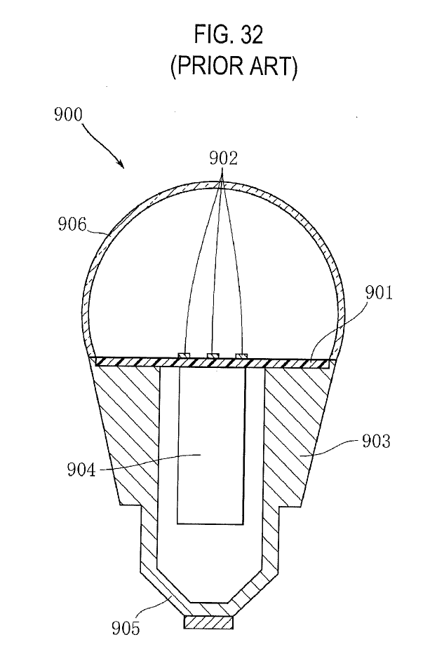

### DETAILED DESCRIPTION

Some embodiments of the present disclosure will now be described in detail with reference to the drawings.

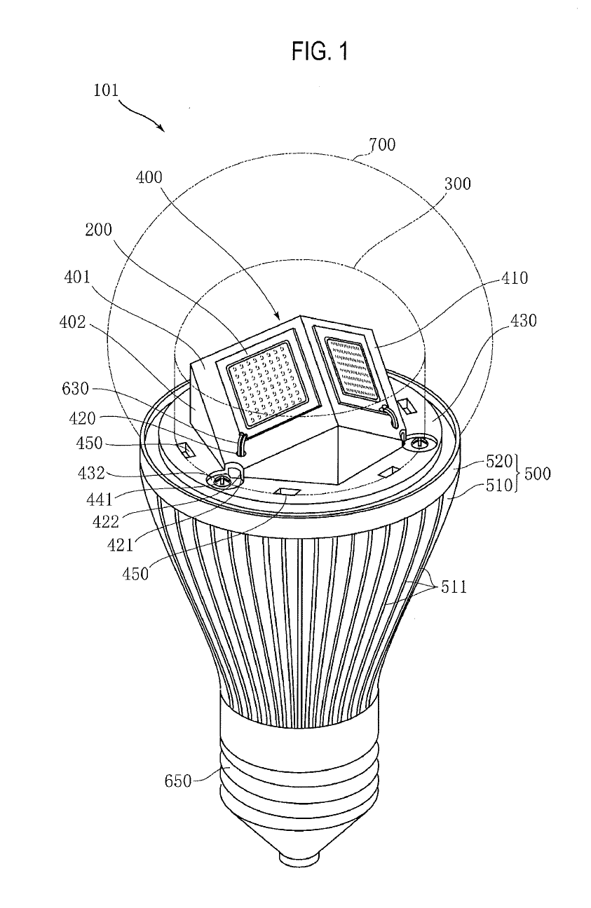

FIGS. 1 to 3 show an LED bulb according to a first embodiment of the present disclosure. In this embodiment, an LED bulb 101 includes a plurality of light emitting parts 200, a case cover 300, a mount 400, a base 500, a power supply 600, a cap 650 and a globe 700. The LED bulb 101 is attached to a lighting apparatus and is employed as a substitute for a general incandescent bulb. In this embodiment, the LED bulb 101 has the full length of about 67 mm and the globe 700 has a diameter of about 35 mm. The LED bulb 101 is intended to be used as a substitute for a bulb, which is called a mini-krypton bulb, by providing the cap 650 of an E17 type defined by JIS.

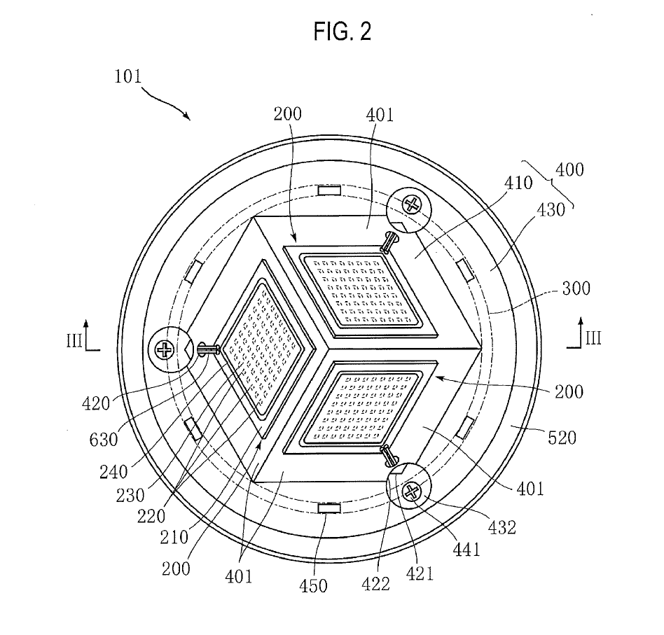

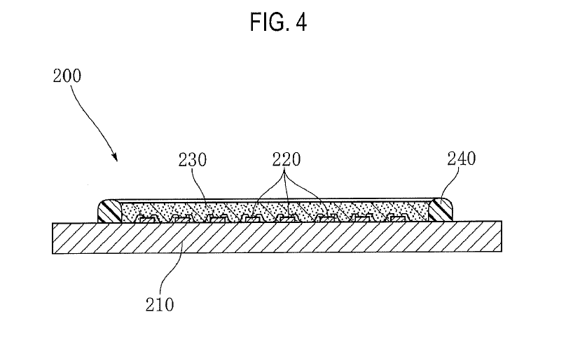

In this embodiment, the number of light emitting parts 200 is three, each of which has a rectangular thin plate shape in its entirety, as shown in FIG. 2. As shown in FIG. 4, each of the light emitting parts 200 includes an LED substrate 210, a plurality of LED chips 220, a sealing resin 230 and a dam portion 240. The LED substrate 210 has a rectangular shape and is made of a ceramic such as alumina. The plurality of LED chips 220 is mounted on each LED substrate 210 formed thereunder with a wire pattern (not shown) serving as a route to supply power to the LED chips 220.

Each LED chip 220 includes a p-type semiconductor layer and an n-type semiconductor layer, which are formed of, for example, a GaN-based semiconductor material. Each LED chip 220 further includes an active layer which is interposed between the p-type semiconductor layer and the n-type semiconductor layer. Each LED chip 220 emits, for example, a blue light. In this embodiment, the LED chip 220 is of a two-wire type, i.e., the LED chip 220 is connected to the wire pattern of the LED substrate 210 via two wires. However, the LED chip 220 is not limited thereto but may be of a one-wire type or a flip chip type. The plurality of LED chips 220 is arranged in the form of a matrix on each LED substrate 210.

The sealing resin 230 seals the plurality of LED chips 220 and is made of a resin material such as silicon resin or epoxy resin. The dam portion 240 is formed in a rectangular edge shape on the LED substrate 210 and is made of, for example, white silicon resin. The dam portion 240 blocks liquefied resin material when forming the sealing resin 230 to prevent the resin material from flowing into an unintended region.

As shown in FIGS. 1 to 3, the mount 400 includes a bulging portion 410 and a jaw plate 430, and is made of metal such as aluminum by casting. Alternatively, the mount 400 may be formed by bending a metal plate.

The bulging portion 410 is a portion bulging toward the inner centers of the case cover 300 and the globe 700. In this embodiment, the bulging portion 410 has three mounting surfaces 401 and a plurality of side surfaces 402. Each mounting surface 401 has a square shape. The three mounting surfaces 401 have the same apex. The sides of adjacent mounting surfaces 401 extending from the apex adjoin each other. With this positional relationship, the three mounting surfaces 401 have a sharp mountain shape with the apex as a summit when viewed from the side and a hexagonal shape when viewed from above. One light emitting part 200 is mounted on one mounting surface 401. In this embodiment, a wire through hole 420 is formed in a lower corner of each mounting surface 401. Each side surface 402 is a surface which extends downward from one of the four sides of a mounting surface 401 that does not adjoin with the side of an adjacent mounting surface 401. The jaw plate 430 extends laterally from the bulging portion 410 and has an annular shape in this embodiment. The jaw plate 430 is formed with a plurality of rectangular fixing holes 450. The plurality of fixing holes 450 is arranged on a circumference surrounding the bulging portion 410.

The bulging portion 410 is formed with three radiating through holes 421. An outer space of the mount 400 is connected to its inner space via the radiating through holes 421. The jaw plate 430 is formed with three bolt through holes 431 and three counterbored holes 432. The bolt through holes 431 function to pass bolts 441 to fix the mount 400 to the base 500. The counterbored holes 432 function to sink the heads of the bolts 441 into the jaw plate 430, and have circular concave portions whose diameters are larger than those of the bolt through holes 431. In this embodiment, when a drilling process is performed to form the counterbored holes 432, a portion of the periphery near an edge of the bulging portion 410 and the jaw plate 430 may be cut. Thus, three notches 422 may be formed in the mount 400. Portions of the notches 422 penetrating through the bulging portion 410 in the thickness direction correspond to the above-mentioned radiating through holes 421. As a result, the counterbored holes 432 are formed by portions of the notches 422. The counterbored holes 432 are filled with a fixing resin 442. The fixing resin 442 is used to prevent the bolts 441 from being loosened, and, in this embodiment, is filled in about half of an area of the counterbored holes 432. In FIGS. 1 and 2, the fixing resin 442 is omitted for the purpose of clarity of understanding.

The base 500 is attached with the mount 400 and, in this embodiment, includes a main body 510 and a spacer 520. The base 500 may be made of a high thermal conductivity material, for example, a metal such as aluminum Alternatively, the base 500 may be formed as an integral product.

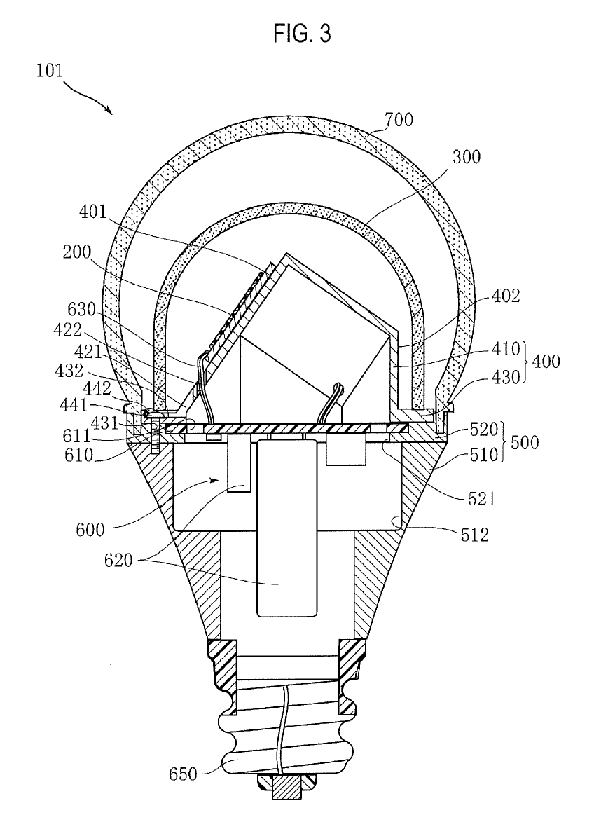

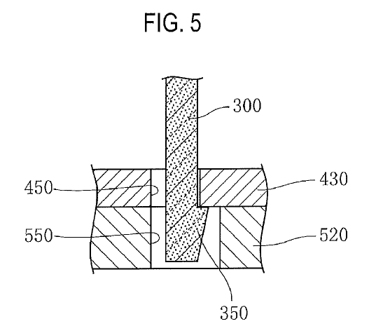

The main body 510 is formed as a semi-ellipsoidal solid in its entirety and has a plurality of fins 511. The plurality of fins 511 has a radial shape, which is formed outward. The main body 510 is formed with a power supply receiving concave portion 512. The power supply receiving concave portion 512 is a portion receiving at least a portion of the power supply 600, and, in this embodiment, receives most of the power supply 600. The spacer 520 has a disc shape and is attached to the top of the main body 510 as shown in FIG. 3. The spacer 520 is formed with an opening 521. The opening 521 is provided to avoid interference with the power supply 600. As shown in FIG. 5, the spacer 520 is also formed with a fixing hole 550.

The case cover 300 corresponds to one example of a diffusive secondary light source which is described in the present disclosure, and covers the bulging portion 410 of the mount 400. In this embodiment, the case cover 300 includes a cylindrical portion surrounding the bulging portion 410 laterally and a domical portion covering the bulging portion 410 from above. The case cover 300 diffuses and transmits light from the light emitting parts 200. In this embodiment, the case cover 300 is made of a mixture of transparent resin with a fluorescent material. This fluorescent material emits a yellow light when it is excited by a blue light from the light emitting parts 200. Through the mixture of the yellow light with the blue light from the light emitting parts 200, the case cover 300 shows an external appearance emitting a white light. The fluorescent material also acts to diffuse light from the light emitting parts 200. As shown in FIG. 5, the case cover 300 is formed with a nail portion 350. The nail portion 350 fastens the case cover 300 to the mount 400 through coupling of the nail portion 350 with the fixing hole 450 of the jaw plate 430 on the mount 400. The fixing hole 550 of the spacer 520 of the base 500 prevents the nail portion 350 from interfering with the spacer 520.

The globe 700 contains the bulging portion 410 on which the light emitting parts 200 is mounted and the case cover 300 which covers the bulging portion 410. The globe 700 transmits light output from the case cover 300. In this embodiment, the globe 700 is adapted to diffuse and transmit light. The globe 700 is made of, for example, opalescent translucent resin. The globe 700 is formed in a partial spherical shape whose diameter is about 35 mm. In this embodiment, as shown in FIG. 3, the case cover 300 is arranged to overlap with the globe 700 in light irradiating direction.

The power supply 600 generates DC power adapted to turn on the light emitting parts 200 (LED chips 220) from, for example, a commercial AC 100 V power source, and supplies the generated DC power to the light emitting parts 200 (LED chips 220). As shown in FIG. 3, the power supply 600 includes a power supply substrate 610, a plurality of electronic components 620 and a plurality of wires 630.

The power supply substrate 610 includes, for example, a glass composite copper clad laminated layer and has a circular shape in its entirety. The plurality of electronic components 620 is mounted on the bottom of the power supply substrate 610. The power supply substrate 610 is disposed to block the opening 521 of the spacer 520 of the base 500. Radiating through holes 611 are formed in the power supply substrate 610. The radiating through holes 611 are provided at the same position as the radiating through holes 421 of the mount 400 when viewed from above.

The plurality of electronic components 620 convert the commercial AC 100 V power source into DC power, which is adapted to turn on the light emitting parts 200 (LED chips 220). The plurality of electronic components 620 includes, for example, a capacitor, a resistor, a coil, a diode, an IC, etc. For example, in FIG. 3 the electronic component 620 is a capacitor, which projects downward substantially in the middle of the power supply receiving concave portion 512.

The wires 630 deliver the DC power from the plurality of electronic components 620 to the light emitting parts 200. The wires 630 reach the light emitting parts 200 from the power supply substrate 610 via the wire through holes 420 on the mount 400.

The cap 650 is a part for attaching the LED bulb 101 to a general bulb lighting apparatus based on, for example, JIS. In this embodiment, the cap 650 is adapted to meet the E17 specification defined by JIS. The cap 650 is connected to the power supply 600 via a wire.

Next, operation of the LED bulb 101 will be described.

According to this embodiment, the light emitting parts 200 mounted on the mounting surfaces 401 of the bulging portion 410 emit light at a position close to the center of the globe 700. The light from the lighting emitting parts 200 propagates upward, laterally and obliquely downward in FIG. 3. This light excites the fluorescent material of the case cover 300 to emit a yellow light and is diffused by the case cover 300. Accordingly, the case cover 300 emits a white light toward an area wider than the light emitted from the light emitting parts 200. The white light is further diffused by the globe 700 covering the case cover 300. Accordingly, in the LED bulb 101, the partially spherical globe 700 shows an external appearance uniformly shining in white in its entirety, which may result in more uniform illumination over a wider range. Such an LED bulb 101 is suitable as a substitute for, for example, a mini-krypton bulb.

The three mounting surfaces 401 are configured to face different directions by the bulging portion 410, which results in a configuration where the three square mounting surfaces 401 collectively share an apex. This allows the three light emitting parts 200 to emit light over a wider range. Each of the mounting surfaces 401 takes a posture of upward inclination, as shown in FIG. 3. The light emitted from the light emitting parts 200 mounted on the mounting surfaces 401 is more likely to propagate in the obliquely downward direction. This makes the LED bulb 101 suitable to be used as a lighting device irradiating a wide range, like a general incandescent bulb.

As described above, the case cover 300 is composed of a cylindrical portion and a domical portion, and the globe 700 has a partially spherical shape. This can prevent light from the case cover 300 from being non-uniformly incident into the globe 700, and is suitable for uniform irradiation of the globe 700.

The provision of the radiating through holes 421 allows heat from the light emitting parts 200 to be transferred to the main body 510 via a space within the bulging portion 410 and the main body 510. The main body 510 includes the plurality of fins 511 to provide excellent heat radiation, as described above. This can prevent the light emitting parts 200 from being unduly heated. The LED substrate 210 made of a ceramic is suitable for the transfer of the heat from the plurality of LED chips 220 to the mount 400.

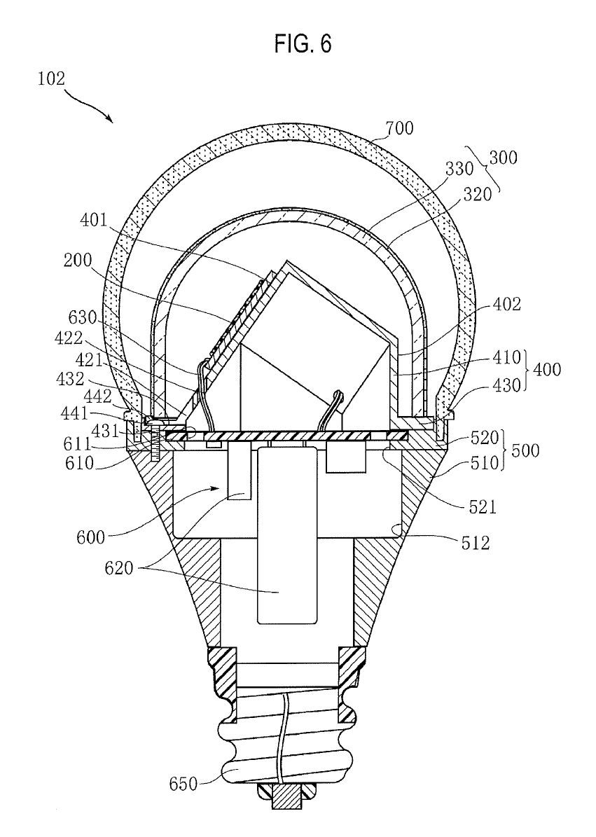

FIGS. 6 to 20 show different embodiments of the present disclosure. In these figures, the same elements as or similar elements to those of the above-described first embodiment are denoted by the same reference numerals.

FIG. 6 shows an LED bulb according to a second embodiment of the present disclosure. In the second embodiment, the LED bulb 102 differs in the configuration of the case cover 300 from that of the first embodiment. In the second embodiment, the case cover 300 includes a fluorescent layer 320 and a transparent layer 330. The transparent layer 330 is made of, for example, transparent epoxy resin or acryl resin. The fluorescent layer 320 is made of a resin mixed with a fluorescent material emitting a yellow light when the fluorescent material is excited by a blue light, and covers the outer side of the transparent layer 330.

Even with this configuration, in the LED bulb 102, the partially spherical globe 700 shows an external appearance uniformly shining in white in its entirety, which may result in more uniform illumination over a wider range. In addition, the blue light from the light emitting parts 200 is likely to be refracted since it has a relatively short wavelength in visible light. The blue light is refracted or reflected in different directions by the transparent layer 330 of the case cover 300. Further, through diffusion of the refracted blue light by the fluorescent layer 320, the white light is expected to be emitted over a wider range.

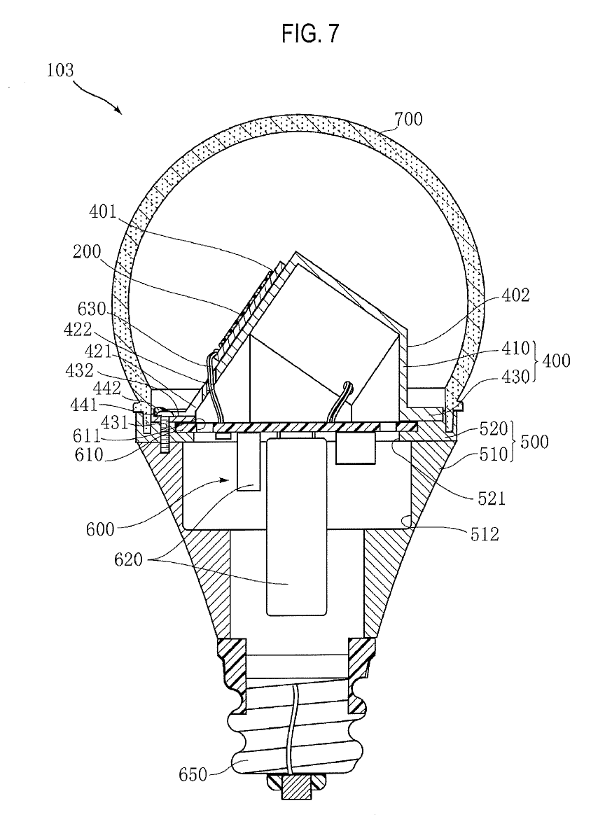

FIG. 7 shows an LED bulb according to a third embodiment of the present disclosure. In the third embodiment, an LED bulb 103 differs from that of the first embodiment in that the former does not include the case cover 300, and also differs in the configuration of the light emitting parts 200 from that of the first embodiment. In this embodiment, the sealing resin 230 of the light emitting parts 200, shown in FIG. 4, is formed by a resin which contains a fluorescent material. The fluorescent material emits a yellow light through excitation by a blue light. With this configuration, the light emitting parts 200 emit a white light. The globe 700 diffuses and transmits the white light from the light emitting parts 200.

Even with this configuration, in the LED bulb 103, as the light emitting parts 200 are disposed near the center of the partially spherical globe 700, the light from the light emitting parts 200 can reach most of the globe 700, which may result in more uniform illumination over a wider range.

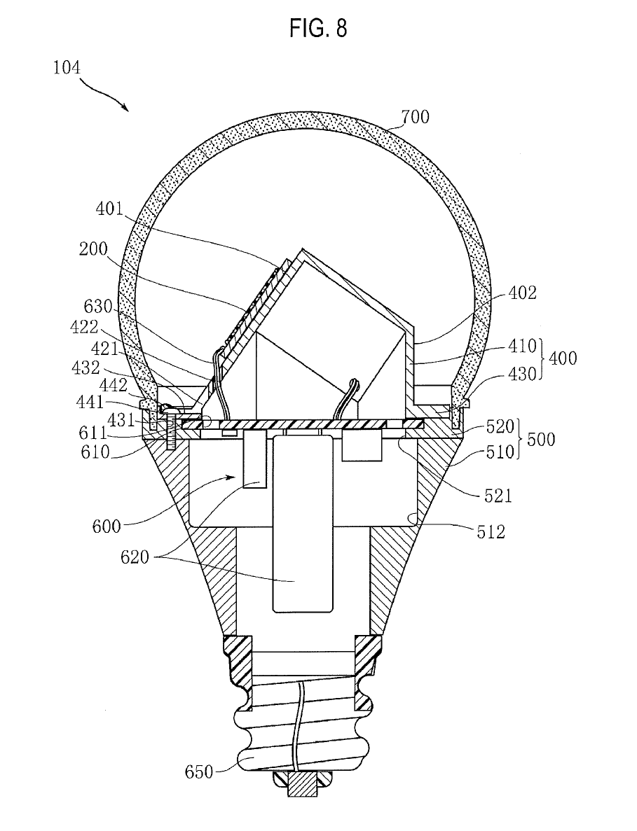

FIG. 8 shows an LED bulb according to a fourth embodiment of the present disclosure. In the fourth embodiment, an LED bulb 104 differs in the configuration of the light emitting parts 200 and the globe 700 from the above-described LED bulb 103. In this embodiment, the light emitting parts 200 emit a blue light. The globe 700 is made of a resin mixed with a fluorescent material. The fluorescent material emits a yellow light through excitation by a blue light. The globe 700 emits the yellow light from the fluorescent material while diffusing and transmitting the blue light from the light emitting parts 200. Accordingly, the globe 700 shows an external appearance with an emission of a white light.

Even with this configuration, in the LED bulb 104, as the light emitting parts 200 are disposed near the center of the partially spherical globe 700, light from the light emitting parts 200 can reach most of the globe 700, which may result in more uniform illumination over a wider range.

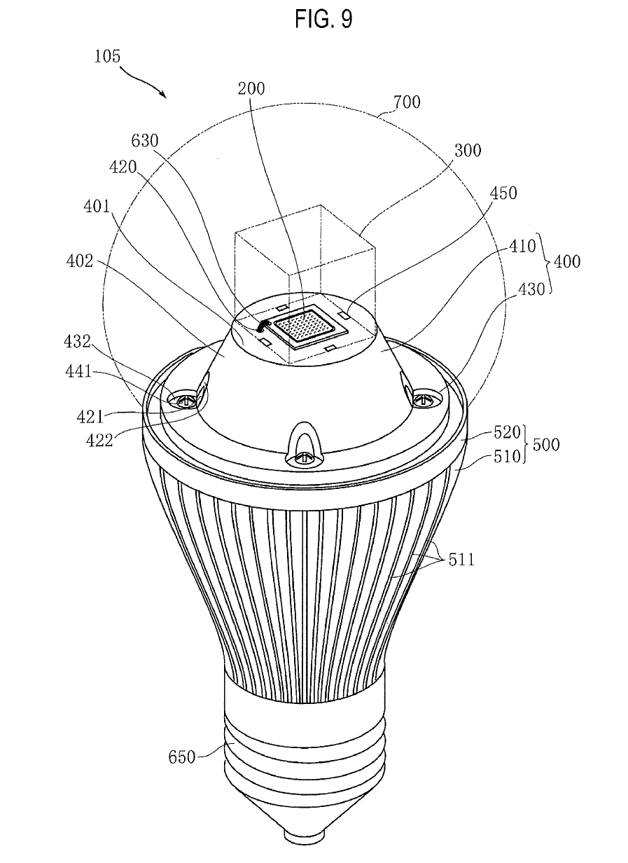

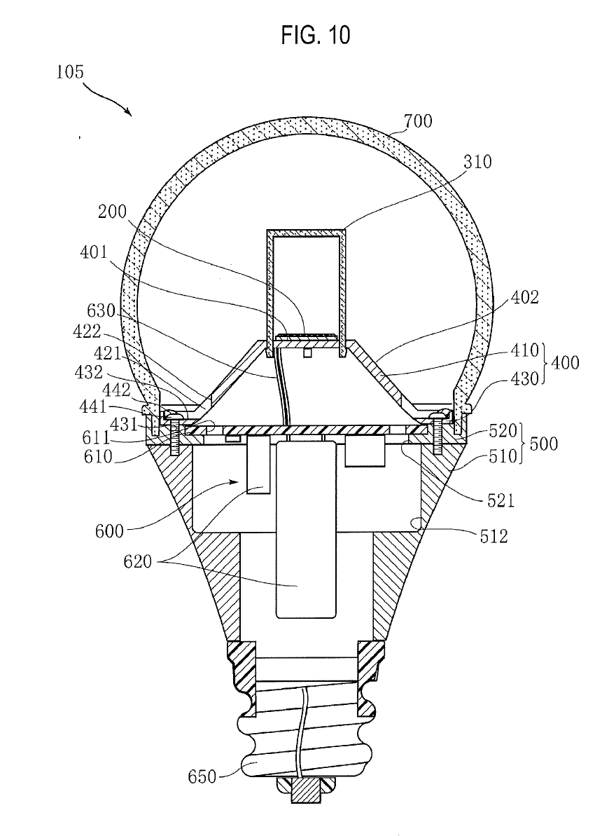

FIGS. 9 and 10 show an LED bulb according to a fifth embodiment of the present disclosure. In the fifth embodiment, an LED bulb 105 differs in the configuration of the mount 400 and the case cover 300 from those of the above described embodiments. In this embodiment, the bulging portion 410 of the mount 400 has a truncated conical shape. The mounting surface 401 has a circular shape contacting a ceiling surface. The side surface 402 has a tapered cylindrical shape whose sectional diameter increases toward the base 500. The mounting surface 401 is formed with a wire through hole 420 and a plurality of fixing holes 450.

The case cover 300 has a rectangular parallelepiped shape and is attached to the mounting surface 401 of the bulging portion 410. In this embodiment, the light emitting part 200 emits a white light. The case cover 300 is constituted by a diffusing layer 310. The diffusing layer 310 is made of, for example, opalescent translucent resin. The globe 700 is also made of, for example, opalescent translucent resin. In addition, the case cover 300 may have a bottomed cylindrical shape, as shown in the sectional view of FIG. 10.

Even with this configuration, in the LED bulb 105, the partially spherical globe 700 shows an external appearance uniformly shining in white in its entirety, which may result in more uniform illumination over a wider range.

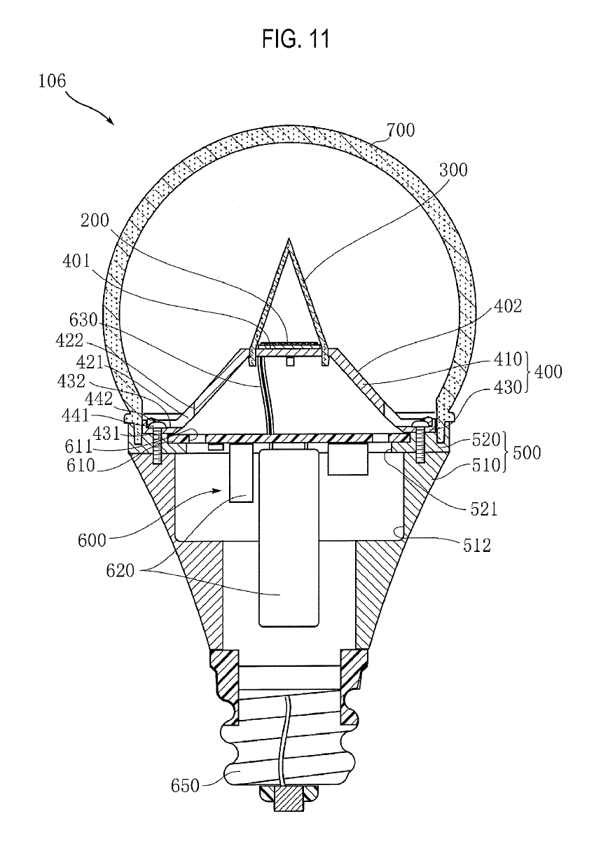

FIG. 11 shows an LED bulb according to a sixth embodiment of the present disclosure. In an LED bulb 106 according to the sixth embodiment, the case cover 300 has a conical shape.

Even with this configuration, in the LED bulb 106, the globe 700 shows an external appearance uniformly shining in white in its entirety, which may result in more uniform illumination over a wider range.

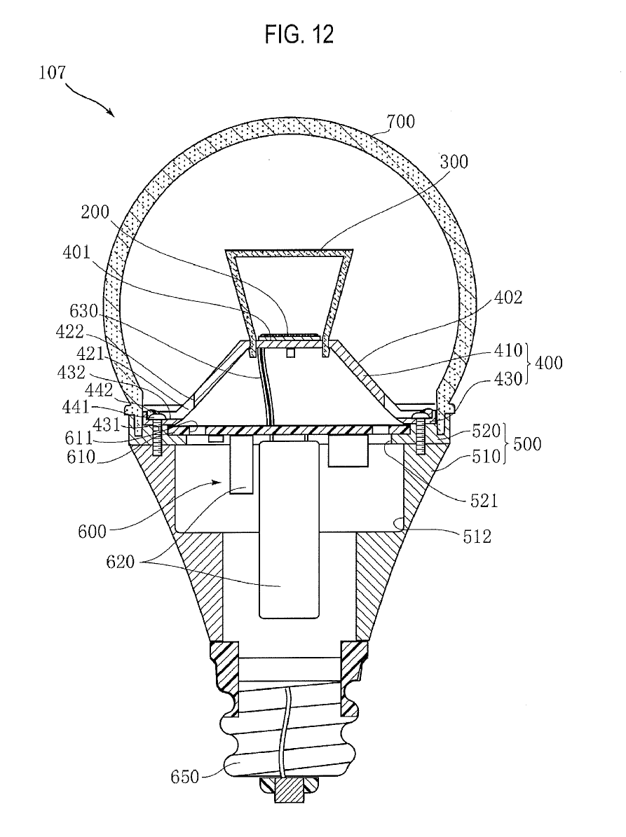

FIG. 12 shows an LED bulb according to a seventh embodiment of the present disclosure. In an LED bulb 107 according to the seventh embodiment, the case cover 300 has a bottomed cylindrical shape having a non-uniform diameter, and a diameter increasing upward from the mount 400.

Even with this configuration, in the LED bulb 107, the globe 700 shows an external appearance uniformly shining in white in its entirety, which may result in more uniform illumination over a wider range.

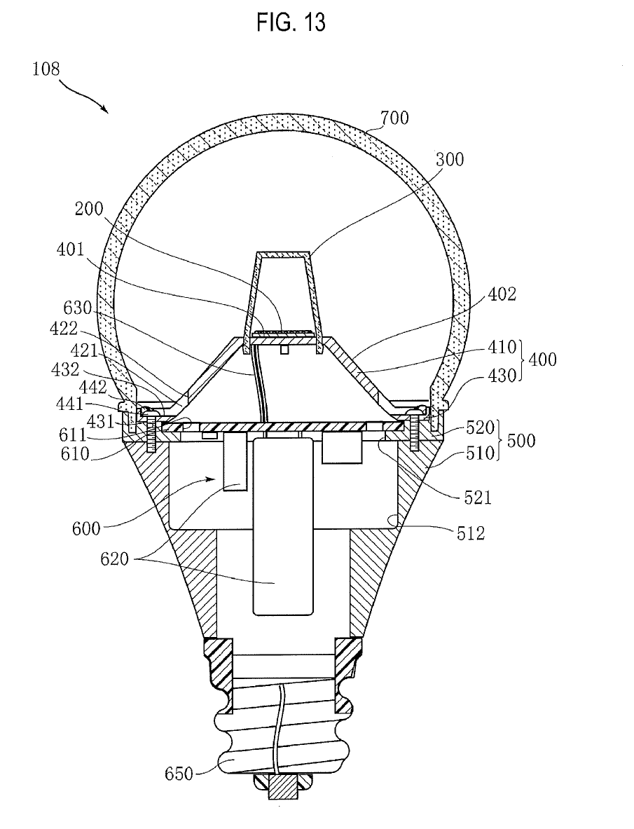

FIG. 13 shows an LED bulb according to an eighth embodiment of the present disclosure. In an LED bulb 108 according to the eighth embodiment, the case cover 300 has a bottomed cylindrical shape having a non-uniform diameter, and a diameter decreasing upward from the mount 400.

Even with this configuration, in the LED bulb 108, the globe 700 shows an external appearance uniformly shining in white in its entirety, which may result in more uniform illumination over a wider range.

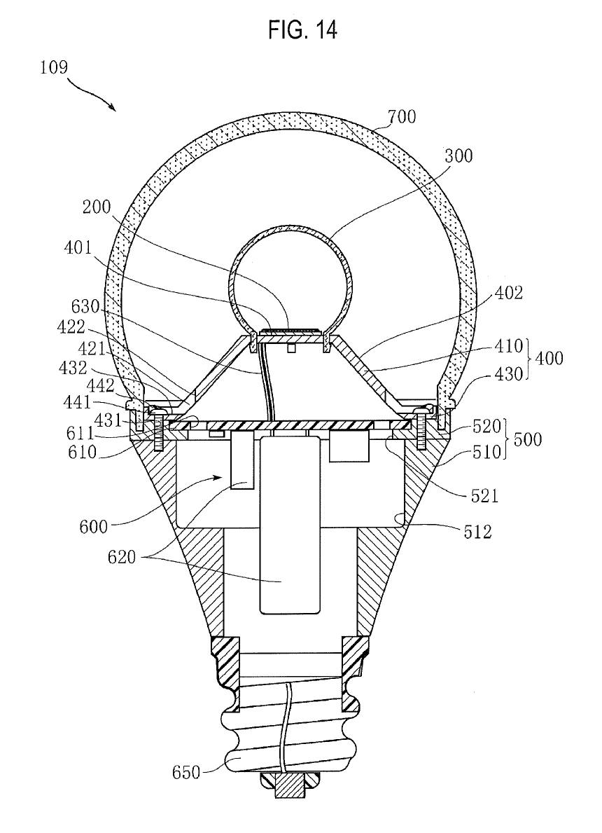

FIG. 14 shows an LED bulb according to a ninth embodiment of the present disclosure. In an LED bulb 109 according to the ninth embodiment, the case cover 300 has a partially spherical shape.

Even with this configuration, in the LED bulb 109, the globe 700 shows an external appearance uniformly shining in white in its entirety, which may result in more uniform illumination over a wider range. In particular, since both the case cover 300 and the globe 700 have a partially spherical shape, a wider region of the globe 700 can shine in white.

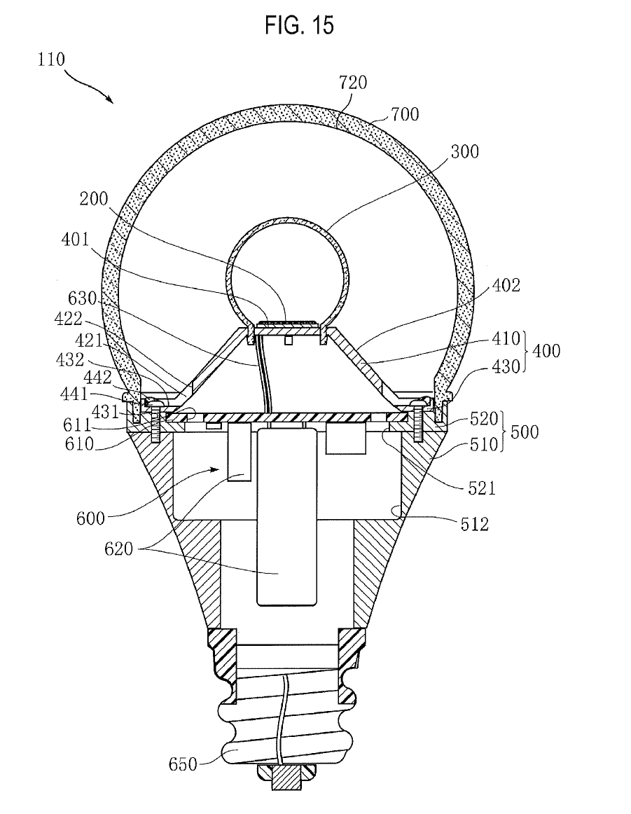

FIG. 15 shows an LED bulb according to a tenth embodiment of the present disclosure. In the tenth embodiment, an LED bulb 110 differs in the configuration of the globe 700 and the light emitting part 200 from the above-described LED bulb 109. In this embodiment, the light emitting part 200 emits a blue light. The globe 700 is constituted by a fluorescent layer 720. The fluorescent layer 720 is made of transparent resin mixed with a fluorescent material. The fluorescent material is a material emitting a yellow light when it is excited by the blue light from the light emitting part 200.

Even with this configuration, in the LED bulb 110, the globe 700 shows an external appearance uniformly shining in white in its entirety, which may result in more uniform illumination over a wider range.

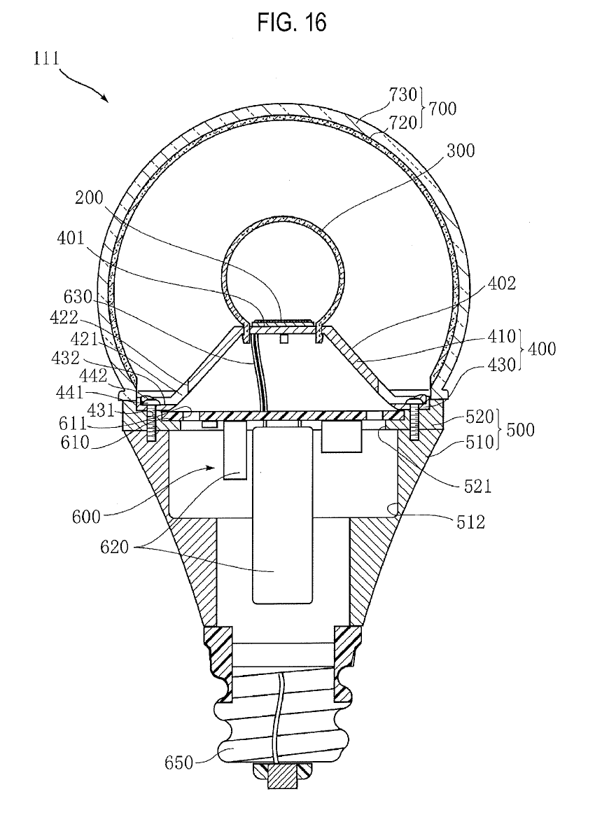

FIG. 16 shows an LED bulb according to an eleventh embodiment of the present disclosure. In the eleventh embodiment, an LED bulb 111 differs in the configuration of the globe 700 from the above-described LED bulb 110. In this embodiment, the globe 700 is composed of a fluorescent layer 720 and a transparent layer 730. The transparent layer 730 is made of, for example, transparent resin material. The fluorescent layer 720 is stacked on an inner side of the transparent layer 730. The fluorescent layer 720 may be formed by spraying the fluorescent material on the inner side of the transparent layer 730 in addition to the configuration in the above-described LED bulb 110.

Even with this configuration, in the LED bulb 111, the globe 700 shows an external appearance uniformly shining in white in its entirety, which may result in more uniform illumination over a wider range.

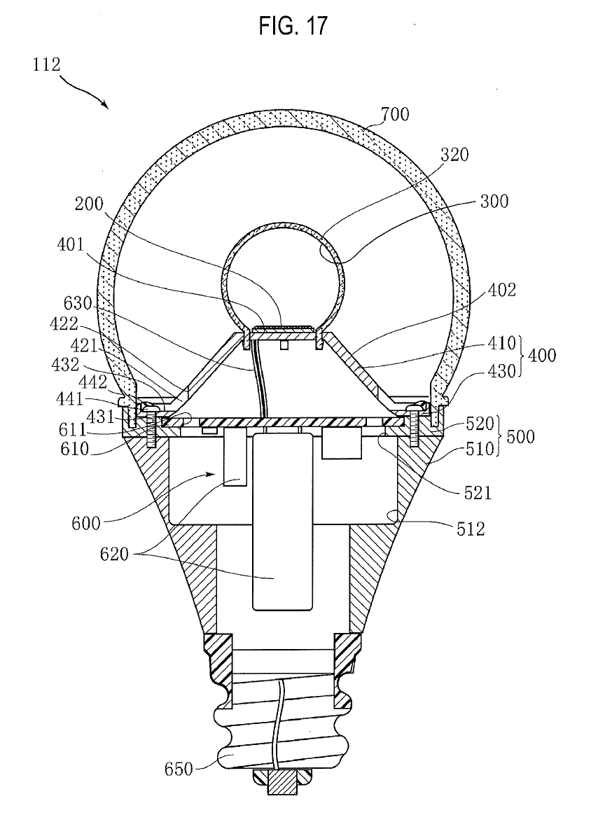

FIG. 17 shows an LED bulb according to a twelfth embodiment of the present disclosure. In an LED bulb 112 according to the twelfth embodiment, the case cover 300 is constituted by a fluorescent layer 320. The fluorescent layer 320 is excited by a blue light to emit a yellow light while diffusing the blue light. The direction of the yellow light from the fluorescent material is random with little dependency on the incident direction of the blue light. The light emitting part 200 is configured to emit a blue light. In the above-described LED bulbs 105 to 109, the case cover 300 may be constituted by the fluorescent layer 320 and the light emitting parts 200 may be configured to emit a blue light.

Even with this configuration, in the LED bulb 112, the globe 700 shows an external appearance uniformly shining in white in its entirety, which may result in more uniform illumination over a wider range.

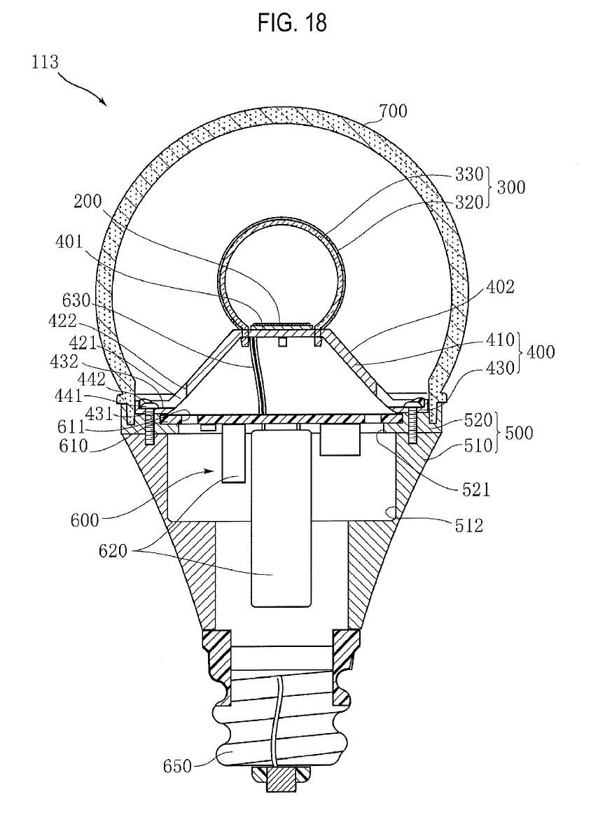

FIG. 18 shows an LED bulb according to a thirteenth embodiment of the present disclosure. In the thirteenth embodiment, an LED bulb 113 differs in the configuration of the case cover 300 from the above-described LED bulb 112. In this embodiment, the case cover 300 includes a fluorescent layer 320 and a transparent layer 330. The transparent layer 330 is made of, for example, transparent resin material. The fluorescent layer 320 is stacked on an outer side of the transparent layer 330. The fluorescent layer 320 may be formed by spraying a fluorescent material on the outer side of the transparent layer 330 in addition to the configuration formed by a resin mixed with the fluorescent material.

Even with this configuration, in the LED bulb 113, the globe 700 shows an external appearance uniformly shining in white in its entirety, which may result in more uniform illumination over a wider range.

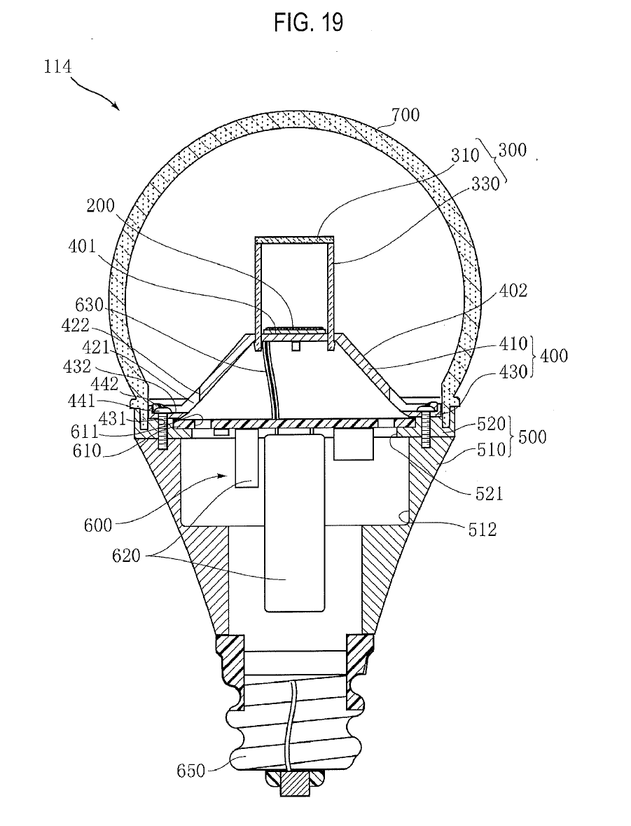

FIG. 19 shows an LED bulb according to a fourteenth embodiment of the present disclosure. In an LED bulb 114 according to the thirteenth embodiment, the case cover 300 is composed of a diffusing layer 310 and a transparent layer 330. The transparent layer 330 has a cylindrical shape and laterally surrounds the light emitting part 200. The diffusing layer 310 has a circular shape and is attached to the top of the transparent layer 330. The diffusing layer 310 is located right above the light emitting part 200. The light emitting part 200 is configured to emit a white light.

Even with this configuration, in the LED bulb 114, the globe 700 shows an external appearance uniformly shining in white in its entirety, which may result in more uniform illumination over a wider range. A portion of the light propagating from the light emitting part 200 into the diffusing layer 310 is reflected downward. The reflected light passes through the transparent layer 330 and propagates in an inclined downward direction. This light reaches the vicinity of a lower end of the globe 700. Accordingly, light with higher brightness can be emitted from the vicinity of the lower end of the globe 700.

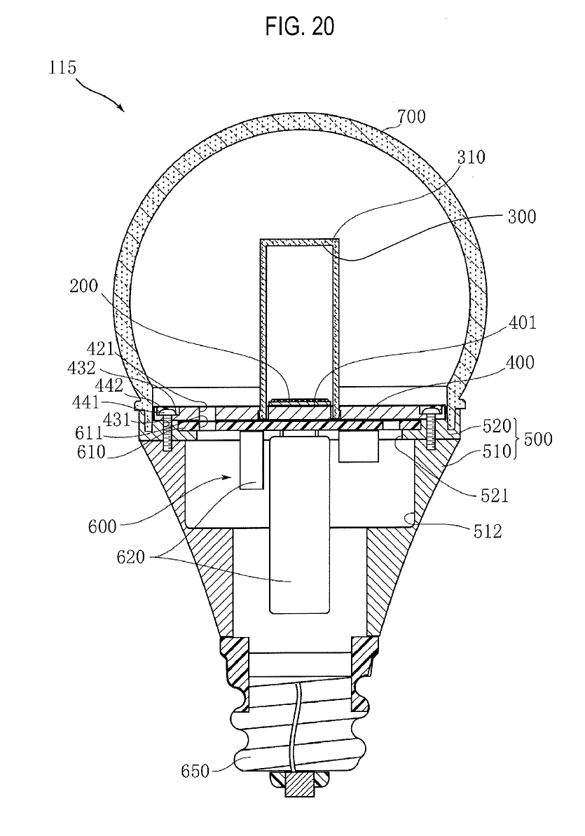

FIG. 20 shows an LED bulb according to a fifteenth embodiment of the present disclosure. In the fifteenth embodiment, an LED bulb 115 differs in the configuration of the mount 400 from those of the above-described embodiments. In this embodiment, the mount 400 has a disc shape and is not provided with the bulging portion 410 of the above-described embodiments. The mounting surface 401 corresponds to the central portion of the top surface of the mount 400. The light emitting part 200 is mounted on the mounting surface 401. The case cover 300 has a rectangular parallelepiped shape or a bottomed cylindrical shape having a relatively large vertical dimension. The case cover 300 has such a height that the central portion of the globe 700, whose horizontal sectional dimension increases in the vertical direction, sufficiently overlaps with the case cover 300 in the vertical direction. Further, the case cover 300 is constituted by the diffusing layer 310 and the light emitting part 200 emits a white light. Alternatively, the case cover 300 may be constituted by a fluorescent layer and the light emitting part 200 may be configured to emit a blue light.

Even with this configuration, in the LED bulb 114, the relatively high case cover 300 within the globe 700 receives light from the light emitting part 200, thereby showing an external appearance shining in white. The globe 700 covering the case cover 300 receives the white light from the case cover 300 over a wider range. Accordingly, the LED bulb 115 can uniformly illuminate over a wider range.

The LED bulbs of the present disclosure are not limited to the above-described embodiments. Details of various parts of the LED bulbs of the present disclosure can be freely modified in design in various ways.

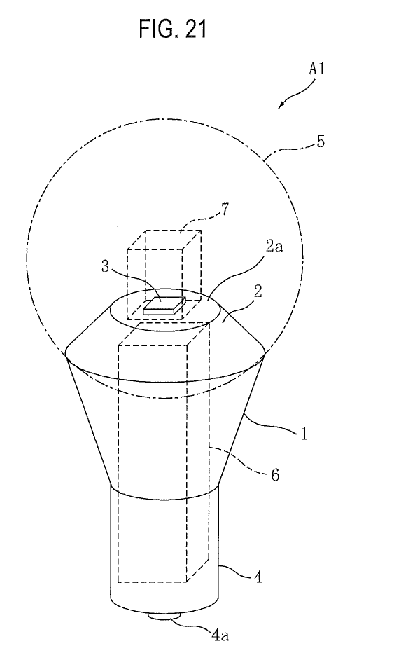

Hereinafter, embodiments of another aspect of the present disclosure will be described with reference to FIGS. 21 to 31.

### First Embodiment

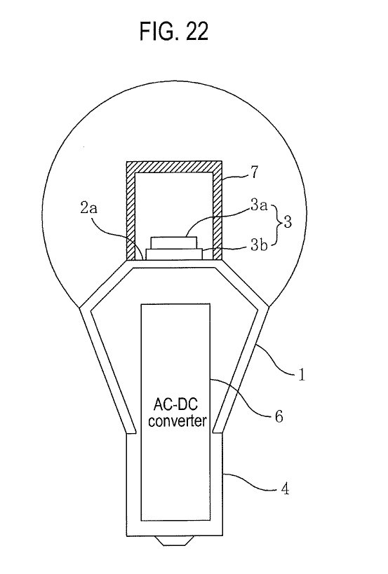

An LED lamp A1 shown in FIGS. 21 and 22 includes a base 1, a mount 2, a light emitting part 3 fixed on the mount 2, a cap 4, a hemispherical globe 5 and a case cover 7. The cap 4 of the LED lamp A1 is configured to be fitted into an established threaded bulb socket (for example a krypton bulb socket (E17 cap)) and the LED lamp A1 may be used as a substitute for a krypton bulb. The globe 5 covers the mount 2 and the light emitting part 3, and is fixed to the base 1. The globe 5 acts to diffuse light from the light emitting part 3.

The base 1 has an internal cavity in which an AC-DC converter 6 is stored. The AC-DC converter 6 is connected to the cap 4 and is connected to the light emitting part 3 via a wire (not shown). The AC-DC converter 6 converts an AC voltage into a DC voltage to be supplied to the light emitting part 3. The mount 2 is inserted to the base 1. The top 2a of the mount 2 projects over the top of the base 1. An end portion of the globe 5 is disposed to be closer to the cap 4 than an end portion of the case cover 7. The base 1 is made of a material having high heat radiation, such as aluminum. Fins (not shown) are formed in an outer wall of the base 1 to provide improved heat radiation.

The light emitting part 3 is a luminous body having a luminous region 3b on which a plurality of LED light emitting elements mounted on a ceramic substrate 3a is disposed (chip-on-board, see FIG. 22). The plurality of LED light emitting elements mounted on the substrate 3a is sealed by sealing resin (not shown). The luminous region 3b has a quadrangular shape. The box-like case cover 7 (inner cover) covering the light emitting part 3 is fixed on the top 2a of the mount 2. The case cover 7 has a parallelepiped shape having sides parallel to the sides of the luminous region 3b.

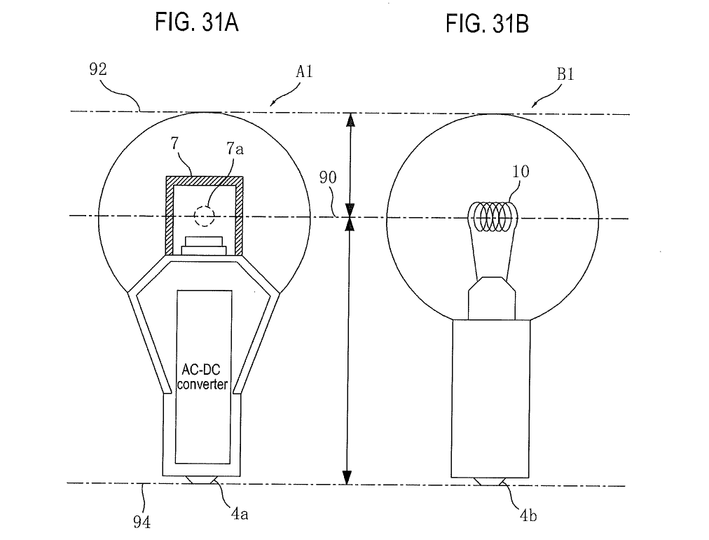

In the first embodiment, the light emitting part 3 is a white light source including a blue LED and a fluorescent material coated thereon, and the case cover 7 is constituted by a diffusing member to diffuse light from the light emitting part 3. The entire surface of the case cover 7 is constituted by a diffusing plate. The light emitted upward from the light emitting part 3 is diffused by the diffusing member, thereby extending an irradiation range to below the mount 2. As shown in FIGS. 31A and 31B, the LED lamp A1 (see FIG. 31A) of the first embodiment is configured such that the center 7a of the case cover 7 coincides with the center of a filament 10 of a conventional krypton bulb B1 (see FIG. 31B) (at a height indicated by a line 90). For example, a distance from a leading end 4a (at a height indicated by a line 94) of a socket to the center 7a of the case cover 7 (the center of the light source (the line 90)) of the LED lamp A1 is approximately equal to a distance from the leading end 4b of the socket of the krypton bulb to the filament 10 of the krypton bulb B1. This distance is about 35 mm to about 45 mm. Accordingly, the light emitted from the case cover 7 has a wider illumination range as compared to the case where the case cover 7 is not present, and an illumination range of the LED lamp A1 is similar to an illumination range of the krypton bulb B1. In addition, since the luminous intensity is distributed by covering the light emitting part 3 with the diffusing member, it is possible to prevent non-uniformity of the luminous intensity (i.e., higher illumination of particular LED elements) when observed from the outside. Further, a distance from the luminosity center 7a (line 90) to a leading end (line 92) of the globe 5 of the LED lamp A1 is approximately equal to a distance from the center (line 90) of the filament 10 to the leading end of the globe 5 of the krypton bulb B1. The distance from line 90 to line 92 is about 15 mm to about 20 mm. Such alignment of the luminosity center provides the following advantages. A krypton bulb has an alignment mechanism which includes an apparatus for engaging with a filament of the bulb (i.e., luminosity center) and an apparatus for coupling the bulb into a socket in an inclined or lateral direction. Since a conventional LED lamp has low luminous intensity in a lateral direction, a conventional LED lamp has an irradiation range biased to a certain direction if the LED lamp is obliquely fitted into the socket in substitute for the krypton bulb. On the other hand, the LED lamp A1 of this embodiment can have a lateral luminosity pattern similar to that of the krypton bulb. For this reason, if an illuminating portion of the LED lamp A1 is fitted into the mechanism of the conventional lamp, e.g., by putting the luminosity center 7a of the LED lamp A1 in the same position as the filament 10, the LED lamp A1 can illuminate in a proper manner.

### Second Embodiment

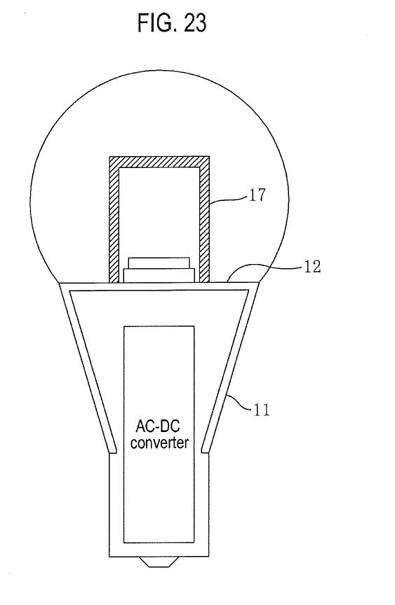

FIG. 23 is a sectional view showing an LED lamp according to a second embodiment. As shown in FIG. 23, in the second embodiment, the top of a mount 12 has the same height as the top of a base 11, unlike in the first embodiment. In addition, a case cover 17 is heightened by the decrease in the height of the top of the mount 12. As a result, the top of the case cover in the second embodiment has the same position as the top of the case cover in the first embodiment. The other configurations are the same in both of the first and second embodiments.

### Third Embodiment

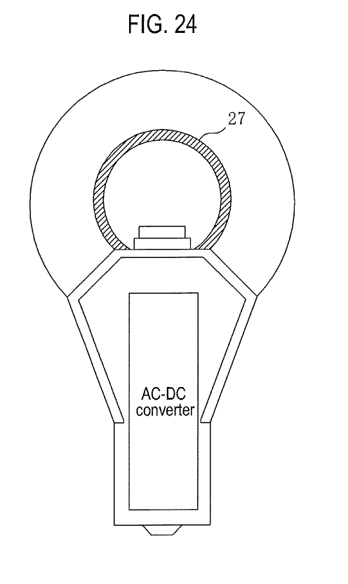

FIG. 24 is a sectional view showing an LED lamp according to a third embodiment. As shown in FIG. 24, the third embodiment uses a hemispherical case cover 27, unlike in the first embodiment, which uses the box-like case cover 7. The other configurations are the same in both of the first and third embodiments.

### Fourth Embodiment

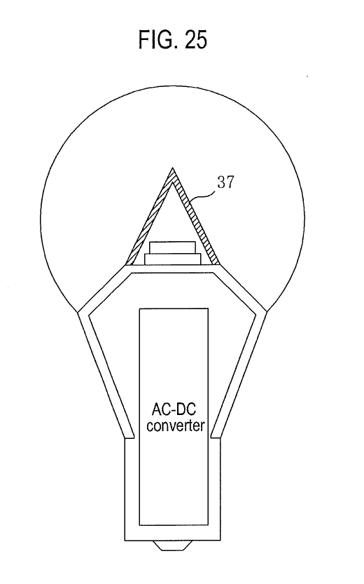

FIG. 25 is a sectional view showing an LED lamp according to a fourth embodiment. As shown in FIG. 25, the fourth embodiment uses a pyramidal case cover 37, unlike in the first embodiment, which uses the box-like case cover 7. The other configurations are the same in both of the first and fourth embodiments.

### Fifth Embodiment

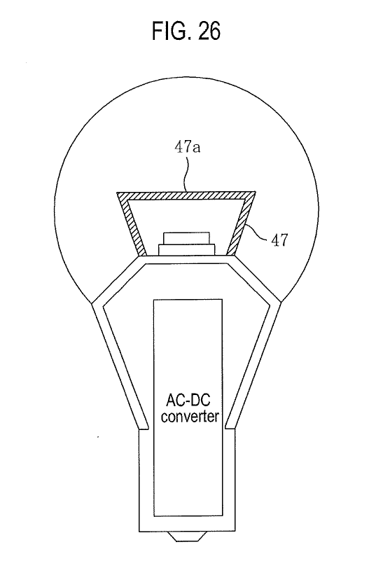

FIG. 26 is a sectional view showing an LED lamp according to a fifth embodiment. As shown in FIG. 26, the fifth embodiment uses a trapezoidal case cover 47, unlike in the first embodiment, which uses the box-like case cover 7. The case cover 47 increases in diameter upward from a fixing end of the mount 2 and a top 47a of the case cover 47 is flat. The other configurations are the same in both of the first and fifth embodiments.

### Sixth Embodiment

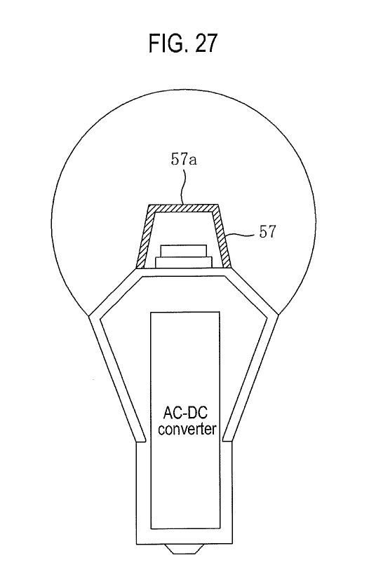

FIG. 27 is a sectional view showing an LED lamp according to a sixth embodiment. As shown in FIG. 27, the sixth embodiment uses a trapezoidal case cover 57, unlike in the first embodiment, which uses the box-like case cover 7. The case cover 57 decreases in diameter upward from a fixing end of the mount 2 and a top 57a of the case cover 57 is flat. The other configurations are the same in both of the first and sixth embodiments.

### Seventh Embodiment

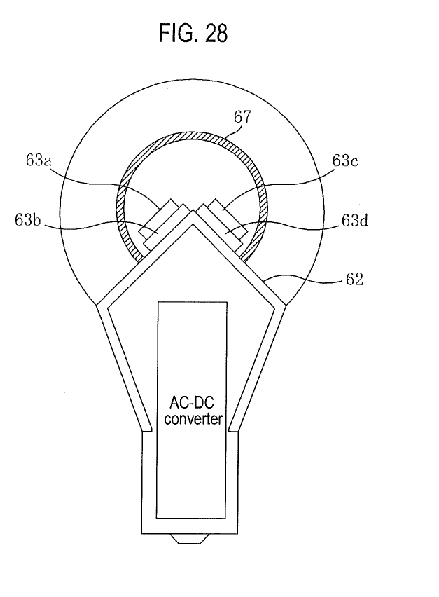

FIG. 28 is a sectional view showing an LED lamp according to a seventh embodiment. As shown in FIG. 28, the seventh embodiment uses a mount 62 having a pyramidal (for example, quadrangular pyramidal) outer side, unlike in the first embodiment, which uses the mount 2 having the flat top 2a. Light emitting parts 3 including luminous region 63a, substrate 63b, luminous region 63c and substrate 63d are provided near the top of the four lateral sides of the quadrangular pyramid. In addition, a hemispherical case cover 67 is provided to cover the light emitting parts 3. Accordingly, the light emitting parts 3 are located approximate to the position of a conventional bulb filament. The other configurations are the same in both of the first and seventh embodiments.

### Eighth Embodiment

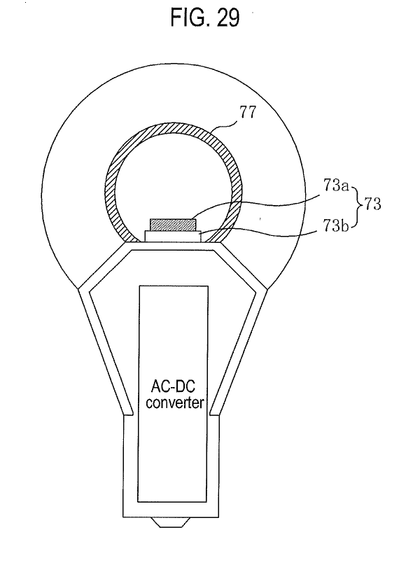

FIG. 29 is a sectional view showing an LED lamp according to an eighth embodiment. As shown in FIG. 29, the eighth embodiment uses a light emitting part 73 including a substrate 73b and a blue light source 73a as a blue LED coated with no fluorescent material, unlike in the first embodiment, which uses a white light source and a diffusing member. A surface of a case cover 77 is coated with a fluorescent material to receive a blue light and emit a white light. The other configurations are the same in both of the first and eighth embodiments.

### Ninth Embodiment

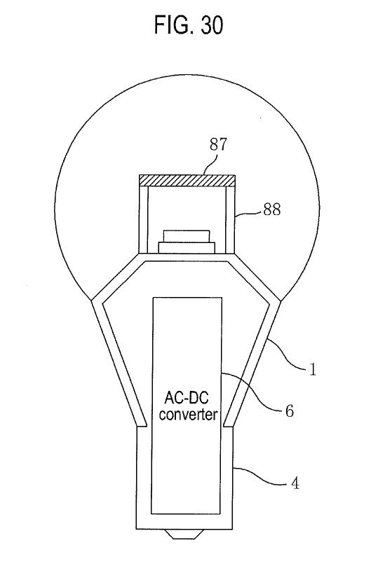

FIG. 30 is a sectional view showing an LED lamp according to a ninth embodiment. As shown in FIG. 30, the ninth embodiment uses a case cover which has a top 87 formed of a diffusing plate and a side 88 made of a non-diffusive transparent plate, unlike in the first embodiment, which uses the case cover 7 having its entire surface composed of a diffusive plate. The top 87 diffuses light from an LED and reflects the light in a downward direction. The other configurations are the same in both of the first and ninth embodiments.

Although it has been illustrated in the above embodiments that the case cover may have rectangular parallelepiped, pyramidal and hemispherical shapes, the case cover may also have other shapes. For example, the case cover may have a shape in rotational symmetry with respect to a central axis, such as a conical shape, a cylindrical shape, a truncated conical shape, etc.

### Aspects of the Present Disclosure

Hereinafter, some additional aspects of the present disclosure, which employ a bulb type LED lightning apparatus, will be additionally stated.

### First Aspect

A first aspect of the present disclosure may provide a bulb type LED lighting apparatus including a power supply, a light emitting diode (LED) chip which receives power from the power supply, a secondary diffusive light source illuminated with light emitted from the LED chip, and a diffusive cover which covers the secondary diffusive light source.

### Second Aspect

In the lighting apparatus of the first aspect, the secondary diffusive light source may be an inner cover which covers the LED chip.

### Third Aspect

In the lighting apparatus of the first aspect, the LED chip may emit a source light having a predetermined wavelength, and the secondary diffusive light source may be a fluorescent generator which generates a fluorescent light having a wavelength longer than the wavelength of the source light through illumination of the fluorescent generator by the source light.

### Fourth Aspect

In the lighting apparatus of the third aspect, the fluorescent generator may be an inner cover which covers the LED chip.

### Fifth Aspect

In the lighting apparatus of the second or fourth aspect, the bulb type LED lighting apparatus may further include a contact part to be inserted in a socket, and an end of the diffusive cover may be disposed closer to the contact part than an end of the inner cover.

### Sixth Aspect

In the lighting apparatus of any one of the second, fourth and fifth aspects, the LED chip may have a quadrangular shape, and the inner cover may have a rectangular parallelepiped shape having sides substantially parallel to the sides of the quadrangular shape.

### Seventh Aspect

In the lighting apparatus of any one of the second, fourth and fifth aspects, the inner cover may be a rotational symmetrical body.

### Eighth Aspect

In the lighting apparatus of the seventh aspect, the inner cover may have substantially a spherical shape.

### Ninth Aspect

In the lighting apparatus of the seventh aspect, the inner cover may have a conical shape.

### Tenth Aspect

In the lighting apparatus of the seventh aspect, the inner cover may have a truncated conical shape.

### Eleventh Aspect

In the lighting apparatus of the seventh aspect, the inner cover may have a cylindrical shape.

### Twelfth Aspect

In the lighting apparatus of any one of the first through the fourth and the sixth through the eleventh aspects, the bulb type LED apparatus may further include a contact part to be inserted in a socket and the center of the secondary diffusive light source may be disposed near the position where a filament would be located in a bulb adapted for an E17 cap.

### Thirteenth Aspect

A thirteenth aspect of the present disclosure may provide a bulb type LED lighting apparatus including a contact part to be inserted in a socket, and a light source having a LED chip as the light source, wherein the center of the light source is located near the position where a filament would be located in a bulb adapted for an E17 cap.

### Fourteenth Aspect

A fourteenth aspect of the present disclosure may provide a bulb type LED lighting apparatus including an E17 cap contact part to be inserted in a socket, a power supply, a light source having a LED chip which receives power from the power supply, a diffusive cover which covers the light source, and a mount part on which the LED chip is mounted, wherein an end of the diffusive cover is disposed closer to the contact part than the mount part.

### Fifteenth Aspect

In the fourteenth aspect of the present disclosure, an inner cover covering the light source may be mounted on the mount part.

While certain embodiments have been described, these embodiments have been presented by way of example only, and are not intended to limit the scope of the disclosures. Indeed, the novel methods and apparatuses described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. An LED bulb comprising:
one or more light emitting parts including one or more LED chips;
a mount including a bulging portion in which one or more mounting surfaces on which the one or more light emitting parts are mounted are formed;
a base attached to the mount; and
a globe which covers the bulging portion and transmits light.

2. The LED bulb of claim 1, further comprising a secondary diffusive light source which covers the bulging portion,
wherein the secondary diffusive light source is interposed with a gap between the light emitting parts and the globe, diffuses and transmits light from the light emitting parts.

3. The LED bulb of claim 2, wherein the secondary diffusive light source includes a fluorescent material which emits light having a wavelength different from a wavelength of light from the LED chips through excitation of the fluorescent material by the light from the LED chips.

4. The LED bulb of claim 3, wherein the secondary diffusive light source is made of transparent resin mixed with the fluorescent material.

5. The LED bulb of claim 3, wherein the secondary diffusive light source includes a transparent layer made of transparent resin and a fluorescent layer including the fluorescent material stacked on the transparent layer.

6. The LED bulb of claim 5, wherein the transparent layer is placed at the side of the light emitting parts with respect to the fluorescent layer.

7. The LED bulb of claim 3, wherein the secondary diffusive light source includes a transparent layer which surrounds a lateral side of the light emitting parts and is made of transparent resin and a fluorescent layer which is located in front of the light emitting parts and includes the fluorescent material.

8. The LED bulb of claim 3, wherein the secondary diffusive light source has one of a rotational symmetrical shape, a cylindrical portion and a domical portion, a conical shape, a truncated conical shape, a bottomed cylindrical shape and a partially spherical shape.

9. The LED bulb of claim 3, wherein the secondary diffusive light source has a rectangular parallelepiped shape.

10. The LED bulb of claim 1, wherein the globe diffuses and transmits light.

11. The LED bulb of claim 1, wherein the bulging portion includes at least three mounting surfaces, and
wherein each of the three mounting surfaces has an apex and two sides extending from the apex, the respective apexes coinciding with each other, and the respective adjacent sides coming in contact with each other.

12. The LED bulb of claim 11, wherein each of the mounting surfaces has a square shape.

13. The LED bulb of claim 1, wherein the bulging portion includes a circular mounting surface and a tapered cylindrical lateral side whose section dimension increases from the circular mounting surface toward the base.

14. The LED bulb of claim 1, wherein the light emitting parts have respective LED substrates on which the one or more LED chips are mounted.

15. The LED bulb of claim 14, wherein each of the LED substrate is made of ceramic.

16. The LED bulb of claim 14, wherein a plurality of LED chips is arranged in the form of a matrix on each of the LED substrates.

17. The LED bulb of claim 14, wherein the light emitting parts have sealing resin which seals the LED chips and transmits light from the LED chips.

18. The LED bulb of claim 17, wherein the light emitting parts include a dam portion which is fowled in an edge shape on the LED substrates and encloses the sealing resin.

19. An LED bulb comprising:
one or more light emitting parts including one or more LED chips;
a mount including one or more mounting surfaces on which the one or more light emitting parts are mounted;
a base attached to the mount;
a globe which covers the light emitting parts and transmits light; and
a secondary diffusive light source which is interposed with a gap between the light emitting parts and the globe, and diffuses and transmits light from the light emitting parts.
